(19) United States
(12) Patent Application Publication
(10) Pub. No.: US 2009/0079208 A1
(43) Pub. Date: Mar. 26, 2009

(54) STRIKER USED FOR VEHICULAR OPENING/CLOSING MEMBER AND ITS MANUFACTURING METHOD

(75) Inventors: Tomoyuki MIZUNO, Obu-city (JP); Katsutaka Tanikawa, Obu-city (JP)

Correspondence Address: OBLON, SPIVAK, MCCLELLAND MAIER & NEUSTADT, P.C., 1940 DUKE STREET, ALEXANDRIA, VA, 22314, US

(73) Assignee: ANSEI CORPORATION, Obu-city (JP)

(21) Appl. No.: 12/190,120

(22) Filed: Aug. 12, 2008

(30) Foreign Application Priority Data
Sep. 24, 2007 (JP) 2007-246345

(51) Int. Cl. E05B 15/02; B23P 11/00

(52) U.S. Cl. 292/340; 29/530

(57) ABSTRACT

A striker further excellent in durability is provided. A striker for a vehicular opening/closing member of the invention includes a base plate made of a steel penetrated with a post hole, and a post projected from the base plate by being caulked in a state of inserting an end portion of a rod member made of steel to the post hole. An inner face of the post hole is formed with at least one groove recessed in an outer direction of a diameter relative to an axis center of the post hole. The end portion clamps a surface side edge and a back face side edge of the post hole and is made to plastically flow at inside of the groove.

### CROSS-REFERENCE TO RELATED APPLICATION

This application claims the benefit of Japanese Patent Application No. 2007-246345 filed on Sep. 24, 2007, the content of which is incorporated herein by reference.

### BACKGROUND OF THE INVENTION

The present invention relates to striker which is used for a vehicular opening/closing member and its manufacturing method.

JP-A-8-25965 discloses a striker which is used for a vehicular opening/closing member of a background art. The striker includes a base plate made of steel penetrated with two post holes, and a post projected from the base plate by being burn-caulked in a state in which one end and other end of a rod member made of steel folded to bend substantially in a U-like shape are inserted to the respective post holes.

The striker of the background art having such a constitution is provided from one side of a door constituting a vehicular opening/closing member and a vehicular main body, engaged with a door latch constituting a lock apparatus of a well-known constitution provided on other side of the door and the vehicular main body and can maintain the door in a closed state.

Meanwhile, the striker of the background art is applied to a vehicle and always receives an impact in running or an impact in opening or closing the opening/closing member, and therefore, there is a case of bringing about rattle in coupling the post to the base plate by a long period of time of use. Therefore, the striker is requested to promote durability.

### BRIEF SUMMARY OF THE INVENTION

The invention has been carried out in view of the actual situation of the background art and it is a problem thereof to be resolved to provide a striker further excellent in durability.

A striker which is used for a vehicular opening/closing member of the invention, and which comprises:

a base plate made of a steel penetrated with a post hole; and

a post projected from the base plate by being caulked in a state of inserting an end portion of a rod member made of a steel to the post hole,

characterized in that

an inner face of the post hole is formed with at least one groove recessed in an outer direction of a diameter relative to an axis center of the post hole; and

the end portion of the rod member clamps a surface side edge and a back face side edge of the post hole and is made to plastically flow at inside of the groove.

According to the striker for a vehicular opening/closing member of the invention having such a constitution, the end portion of the rod member clamps the surface side edge and the back face side edge of the post hole and is made to plastically flow at inside of the groove formed at the inner face of the post hole, and therefore, coupling of the post to the base plate becomes further solid. Therefore, rattle is difficult be brought about in the coupling of the post to the base plate even when an impact in running a vehicle or an impact in opening and closing the opening/closing member is always received.

Therefore, the striker for the vehicular opening/closing member of the invention can achieve excellent durability.

### BRIEF DESCRIPTION OF THE SEVERAL VIEWS OF THE DRAWINGS

Hereinafter, embodiments 1 to 3 that embody the invention will be described with reference to the drawings.

FIG. 1 is a perspective view of a striker for a vehicular opening/closing member of Embodiment 1.

FIG. 2 is a perspective view related to the striker for a vehicular opening/closing member of Embodiment 1, showing a state before inserting one end and other end of a rod member substantially in a U-like shape to respective post holes.

FIG. 3 is a sectional view related to the striker for a vehicular opening/closing member of Embodiment 1, showing a III-III section of FIG. 2.

FIG. 4 is a sectional view related to the striker for a vehicular opening/closing member of Embodiment 1, showing a state (state of arranging step) after inserting the one end and the other end of the rod member substantially in the U-like shape to the respective post holes (showing the III-III section of FIG. 2).

FIG. 5 is a sectional view related to the striker for a vehicular opening/closing member of Embodiment 1, showing a state (state of arranging step) immediately before starting a burn-quenching step (showing a section of making V-V section of FIG. 4 upside down).

FIG. 6 is a sectional view related to the striker for a vehicular opening/closing member of Embodiment 1, showing a state of finishing the burn-caulking step (showing the section of making the V-V section of FIG. 4 upside down).

FIG. 7 is a sectional view related to the striker for a vehicular opening/closing member of Embodiment 1, showing a VII-VII section of FIG. 1.

FIG. 8 is a sectional view of a base plate related to a striker for a vehicular opening/closing member of Embodiment 2, showing grooves turning around inner faces of respective post holes (showing the III-III section of FIG. 2).

FIG. 9 is a sectional view related to a striker for a vehicular opening/closing member of Embodiment 3, showing a rod member having stepped portions at one end and other end thereof (showing the III-III section of FIG. 2).

FIG. 10 is a sectional view related to the striker for a vehicular opening/closing member of Embodiment 3, showing a modified example of a rod member (showing the III-III section of FIG. 2).

FIG. 11 is a perspective view showing a striker for a vehicular opening/closing member of a modified example.

### DETAILED DESCRIPTION OF THE PREFERRED EMBODIMENTS

### Embodiment 1

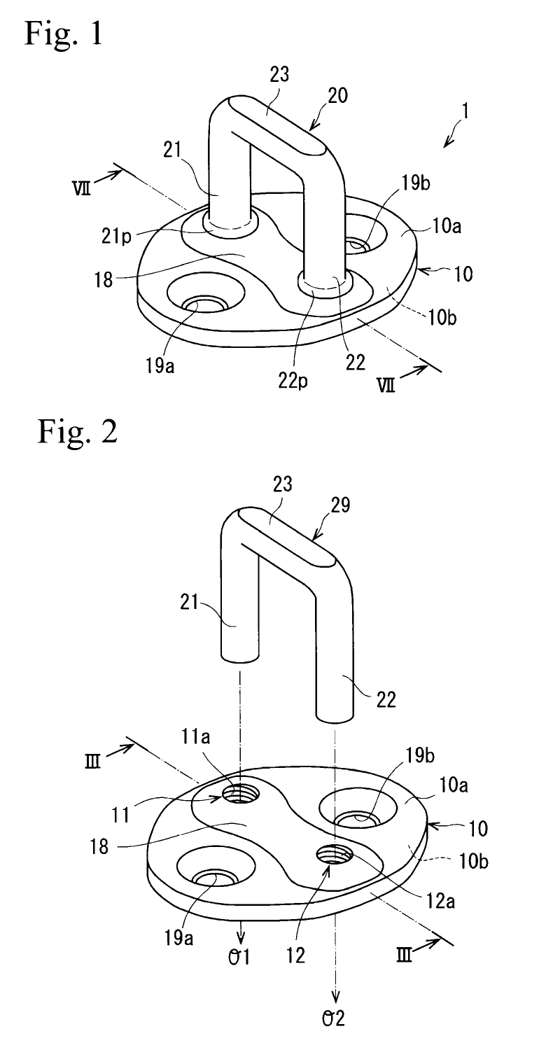

As shown by FIG. 1, a striker 1 which is used for a vehicular opening/closing member of Embodiment 1 includes a base plate 10, and a post 20 substantially in a U-like shape projected to a side of a surface 10a of the base plate 10. The striker 1 is provided on one side of a vehicular opening/closing member of a door or the like and engaged with a lock apparatus provided on other side of the vehicular opening/closing member and a vehicular main body for maintaining the vehicular opening/closing member to stay to be in a closed state. A well-known one of the lock apparatus can be adopted, and therefore, an explanation thereof will be omitted and the striker 1 will be explained in details.

The striker 1 is manufactured by a manufacturing method including a preparing step, a groove forming step, an arranging step, and a burn-caulking step. The respective steps will be explained successively as follows.

### <Preparing Step>

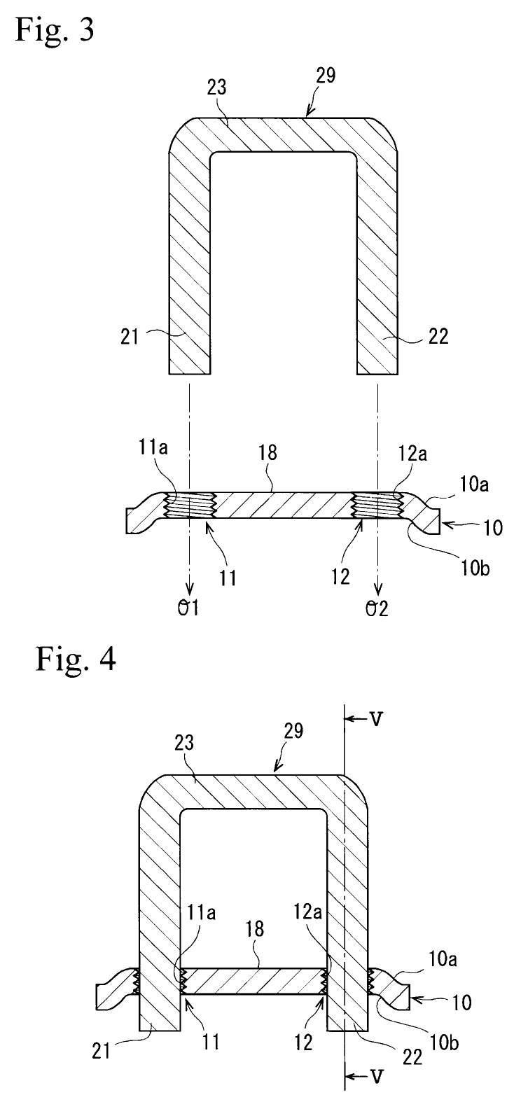

At the preparing step, as shown by FIG. 2 and FIG. 3, the base plate 10 and a rod member 29 are prepared.

The base plate 10 is constituted by pressing a plate member made of steel in a rhombic shape. As a material of the base plate 10, a general hot-rolled steel plate or the like is used.

As shown by FIG. 2, at the base plate 10 before the post 20 is projected therefrom, two attaching holes 19a and 19b are penetrated at vicinities of two corners opposed to each other of four corners of substantially a rhombus. The attaching holes 19a and 19b are utilized when the striker 1 is fastened to be fixed to the vehicular opening/closing member or the vehicular main body.

Further, the base plate 10 is formed with a projected portion 18 slenderly raised to a side of the surface 10a on a diagonal line connecting other two corners opposed to each other. The projected portion 18 is formed by pressing, and therefore, as shown by FIG. 3, a portion on a side of a back face 10b of the base plate 10 in correspondence with the projected portion 18 is considerably recessed. Both end sides of a long side of the projected portion 18 are penetrated with two post holes 11 and 12.

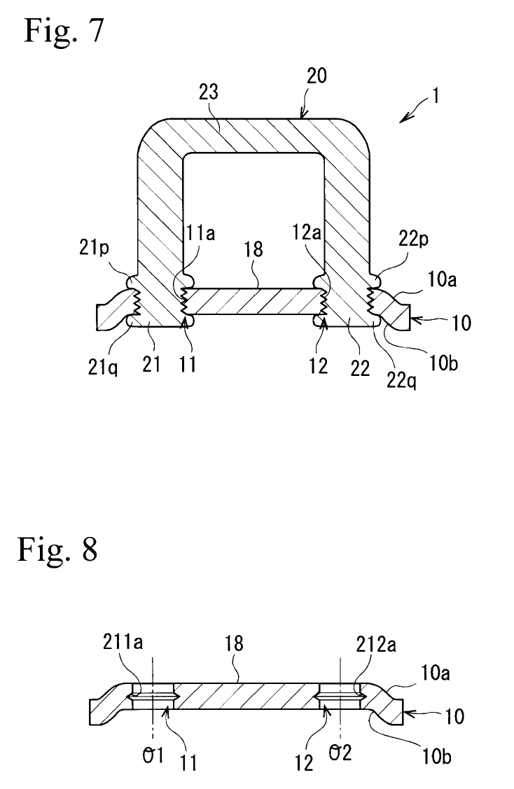

The rod member 29 is to constitute the post 20 as shown by FIG. 1 and FIG. 7 at a stage of finishing the method of manufacturing the striker 1. The rod member 29 is constituted by folding to bend a round bar made of steel substantially in a U-like shape as shown by FIG. 2 and FIG. 3. As a material of the rod member 29, carbon steel, allow steel or the like is generally used since a strength higher than that of the base plate 10 is requested.

### <Groove Forming Step>

In the groove forming step, as shown by FIG. 2 and FIG. 3, inner face of the respective post holes 11 and 12 are respectively formed with single streaks of screw grooves 11a and 12a recessed in outer directions of diameters relative to axis centers O1 and O2 of the respective post holes. The screw grooves 11a and 12a can easily be formed by using a general screwing tool of a tap or the like. As shown by FIG. 4, inner diameters of the respective screw grooves 11a and 12a are made to be slightly larger than outer diameters of one end 21 and other end 22 to be able to insert the one end 21 and the other end 22 constituting end portions of the rod member 29.

### <Arranging Step>

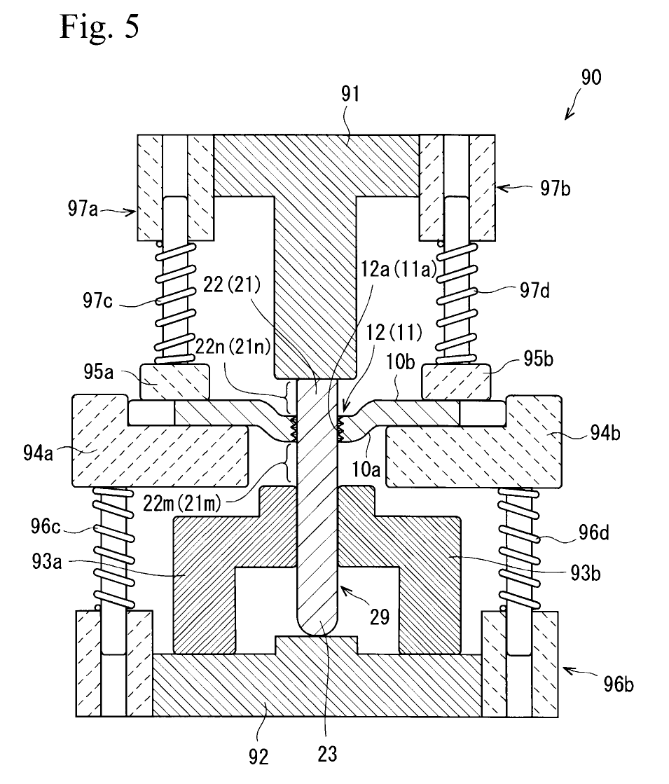

At the arranging step, as shown by FIG. 4, the one end 21 and the other end 22 of the rod member 29 are brought into a state of being inserted to the respective post holes 11 and 12. Further, as shown by FIG. 5, by a burn-caulking apparatus 90, the base plate 10 and the rod member 29 are held to stay in the state shown in FIG. 4 by making upside down (FIG. 5 shows sectional view of making the V-V section of FIG. 4 upside down). The burn-caulking apparatus 90 will be explained further in details. As shown by FIG. 5, the burn-caulking apparatus includes a back face side electrode 91 disposed on a side of the back face 10b of the base plate 10 (upper side of paper face of FIG. 5) and brought into contact with the one end 21 and the other end 22 of the rod member 29, and a surface side electrode 92 disposed on a side of the surface 10a of the base plate 10 (lower side of paper face of FIG. 5) and brought into contact with a bottom portion 23 substantially in the U-like shape of the rod member 29. Further, in FIG. 5, the one end 21 is disposed on a depth side of paper face of other end 22 and the post hole 11 is disposed on depth side of paper face of the post hole 12.

Further, the burn-caulking apparatus 90 includes a pair of movable electrodes 93a and 93b disposed between the surface 10a of the base plate 10 and the surface side electrode 92 for clamping a middle portion of the rod member 29 from two side directions (left and right direction of paper face of FIG. 5). The movable electrodes 93a and 93b are constituted to clamp the middle portion of the rod member 29 by being proximate to each other from a state of being remote from each other to left and right sides.

Further, the burn-caulking apparatus 90 includes rails 94a and 94b made of an insulating material brought into contact with peripheral edges on the side of the surface 10a of the base plate 10, and holding portions 95a and 95b made of an insulating material brought into contact with peripheral edges on the side of the back face 10b of the base plate 10. The rails 94a and 94b are supported movably to a lower side by straight moving guides 96a and 96b arranged at side faces of the surface side electrode 92 and coil springs 96c and 96d. The holding portions 95a and 95b are supported movably to the upper side by straight moving guides 97a and 97b arranged at side faces of the back face side electrode 91 and coil springs 97c and 97d. Further, the base plate 10 and the rod member 29 are restricted to a predetermined relative positional relationship by clamping the base plate 10 by the rails 94a and 94b and the holding portions 95a and 95b.

As shown by FIG. 5, portions of the one end 21 and the other end 22 of the rod member 29 disposed between the surface 10a of the base plate 10 and end faces of the movable electrodes 93a and 93b opposed to the base plate 10 are referred to as surface side caulking ball volume portions 21m and 22m. Further, in FIG. 5, the surface side caulking ball volume portion 21m is disposed on depth side of paper face of the surface side caulking ball volume portion 22m. Further, portions of the one end 21 and the other 22 of the rod member 29 disposed between the back face 10a of the base plate 10 and end faces of the back face side electrode 91 opposed to the base plate 10 are referred to as back face side caulking ball volume portions 21n and 22n. Further, in FIG. 5, the back face side caulking ball volume portion 21n is disposed on depth side of paper face of the back face side caulking ball volume portion 22n.

### <Burn-Caulking Step>

At the burn-caulking step, in a state shown in FIG. 5, electricity is conducted between the back face side electrode 91 and the surface side electrode 92 and the movable electrodes 93a and 93b for a constant period of time. Then, the rod member 29 per se generates heat by an electric resistance and the one end 21 and the other end 22 are softened. At this occasion, the surface side caulking ball volume portions 21m and 22m and the back face side caulking ball volume portions 21n and 22n and the middle portions therebetween particularly generate heat to be softened.

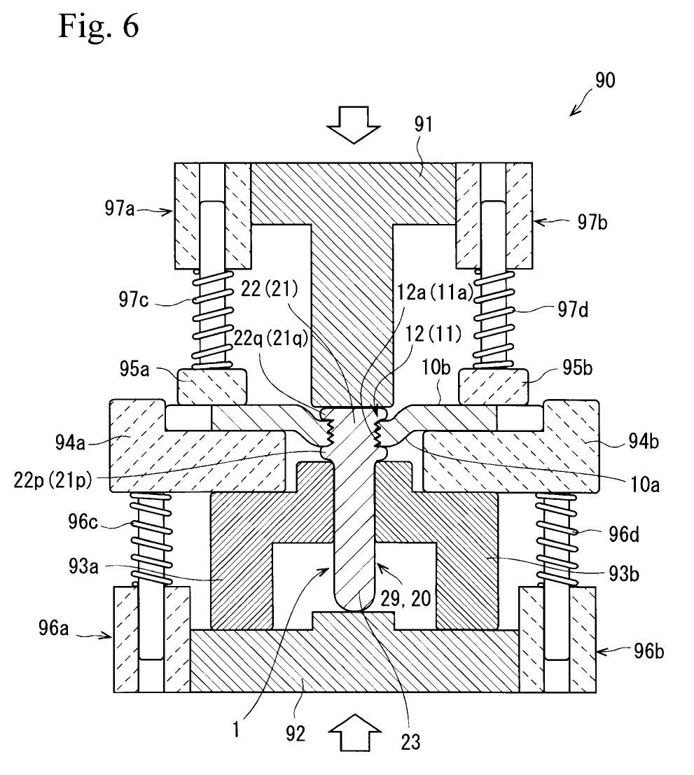

Further, the back face side electrode 91 and the surface side electrode 92 are pressed to be proximate to each other to constitute a predetermined distance therebetween by a press-apparatus, not illustrated, under the state. Then, the relative positional relationship between the back face side electrode 91 and the surface side electrode 92 and the movable electrodes 93a and 93b is displaced from a state shown in FIG. 5 to a state shown in FIG. 6. In accordance therewith, as shown by FIG. 6, also the coil springs 96c, 96d, 97c, and 97d are compressed and also the rails 94a and 94b and the holding portions 95a and 95b are displaced while clamping the base plate 10. Further, end faces of the rails 94a and 94b opposed to the movable electrodes 93a and 93b are butted to and stopped by the movable electrodes 93a and 93b.

In this way, when the back face side electrode 91 and the surface side electrode 92 constitute the predetermined distance therebetween, the surface side caulking ball volume portions 21m and 22m and the back face side caulking ball volume portions 21n and 22n and the middle portions therebetween which are softened are plastically made to flow to deform. As a result, the surface side caulking ball volume portions 21m and 22m and the back face side caulking ball volume portions 21n and 22n become surface side caulking ball portions 21p and 22p and back face side caulking ball portions 21q and 22q in a shape crashed to a flange-like shape. Further, also the middle portions of the surface side caulking ball volume portions 21m and 22m and the back face side caulking ball volume portions 21n and 22n are made to flow plastically to be brought into a state of being filled in the screw grooves 11a and 12a.

When the base plate 10 and the rod member 29 are cooled to a predetermined temperature while staying in the state shown in FIG. 6, the rod member 29 constitutes the post 20 projected from the base plate 10 by burning to caulk the one end 21 and the other end 22. Further, the striker 1 shown in FIG. 1 and FIG. 7 is taken out from the burn-caulking apparatus 90.

According to the striker 1 finished with the above-described respective steps and constituting a product by further being subjected to a heat treatment and a plating treatment, as shown by FIG. 7, the surface side caulking ball portions 21p and 22p and the back face side caulking ball portions 21q and 22q formed at the one end 21 and the other end 22 clamp surface side edges and back face side edges of the respective post holes 11 and 12. In addition thereto, portions of the one end 21 and the other end 22 are made to plastically flow to constitute a state of being filled at inside of the screw grooves 11a and 12a formed at the inner faces of the post holes 11 and 12. Therefore, coupling of the post 20 to the base plate 10 becomes further solid. Therefore, rattle is difficult to be brought about in the coupling of the post 20 to the base plate 10 even when the impact in running the vehicle and the impact in opening or closing the opening/closing member are always received.

Therefore, the striker 1 for the vehicular opening/closing member of Embodiment 1 can achieve excellent durability.

Further, the striker 1 is subjected to a heat treatment or a plating treatment after the burn-caulking step. Here, a steel member having a strength comparatively higher than that of a general steel member used in the base plate 10 is used, and therefore, in heating or cooling by the heat treatment or the plating treatment, a thermal stress owing to a difference between linear expansion coefficients is generated between the post and the base plate. However, the striker 1 is made to be difficult to be effected with the influence of heating and cooling since the coupling of the post 20 to the base plate 10 is made to be further solid, and a rate of bringing about rattle can be reduced. As a result, the striker 1 can also realize a high yield.

### Embodiment 2

According to a striker of Embodiment 2, grooves 211a and 212a shown in FIG. 8 are adopted in place of the screw grooves 11a and 12a of the striker 1 of Embodiment 1. Other constitution is the same as that of the striker 1 of Embodiment 1, and therefore, the same notations are attached to the constitutions the same as those of Embodiment 1 and an explanation thereof will be omitted.

The grooves 211a and 212a are formed to be recessed in outer directions of diameters relative to the axis centers O1 and O2 of the respective post holes 11 and 12 and to turn around inner faces of the respective post holes 11 and 12. The grooves 211a and 212a can easily be worked by general boring.

Also the striker of Embodiment 2 constructing such a constitution can achieve the excellent durability by reason similar to that of the striker 1 of Embodiment 1.

Further, although in Embodiment 2, the grooves 211a and 212a are respectively provided singly, the respective grooves may be formed in plural in a thickness direction of the base plate 10.

### Embodiment 3

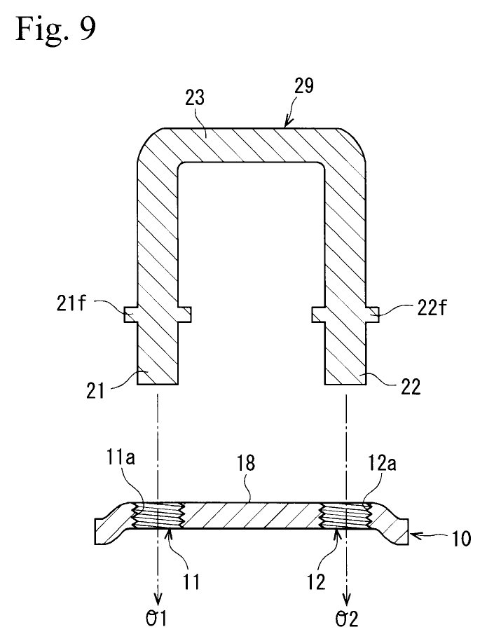

According to a striker of Embodiment 3, with regard to the rod member 29 of the striker 1 of Embodiment 1, as shown by FIG. 9, the one end 21 and the other end 22 are changed to include stepped portions 21f and 22f. Other constitution is the same as that of the striker 1 of Embodiment 1, and therefore, the same notations are attached to constitutions the same as those of Embodiment 1 and an explanation thereof will be omitted.

The one end 21 and the other end 22 of the rod member 29 include the stepped portions 21f and 22f in a flange-like shape. According to the stepped portions 21f and 22f, outer diameters of which are made to be sufficiently larger than diameters of valleys of the screw grooves 11a and 12a such that the stepped portions 21f and 22f are brought into contact with peripheral edges of the respective post holes 11 and 12 on the side of the surface 10a of the base plate 10 when inserted to the respective post holes 11 and 12.

According to the striker of Embodiment 3 constituted in this way, the stepped portions 21f and 22f are previously formed, and therefore, caulking ball portions larger than the surface side caulking ball portions 21p and 22p of the striker 1 of Embodiment 1 are formed. Therefore, according to the striker of Embodiment 3, the one end 21 and the other end 22 can further firmly clamp surface side edges and back face side edges of the respective post holes 11 and 12, and therefore, operation and effect of the invention can further firmly be achieved.

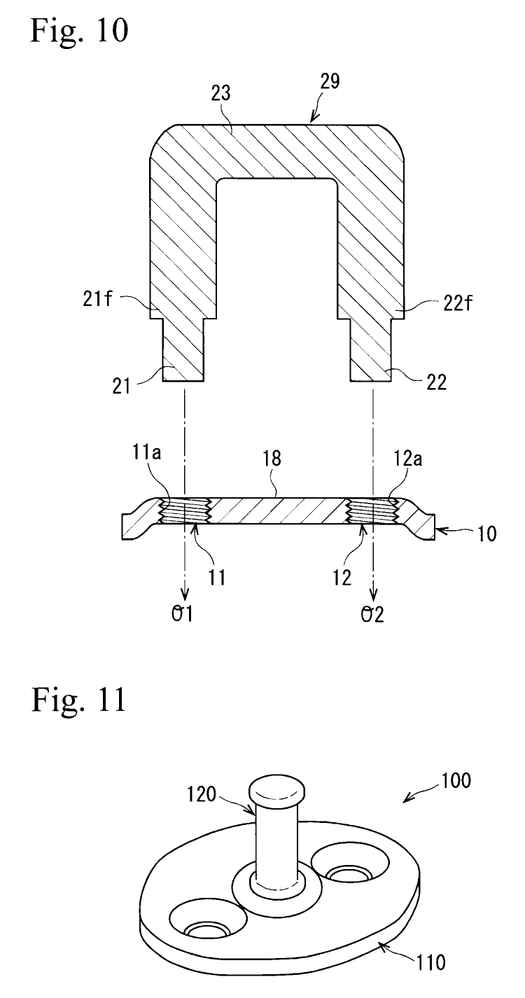

Further, as shown by FIG. 10, the rod member 29 may be constituted by a shape in which large diameter sides of the stepped portions 21f and 22f are continued to the bottom portion 23 substantially in the U-like shape while maintaining outer diameters thereof. In this case, working of the rod member 29 in a prestage of folding to bend the rod member 29 substantially in the U-like shape can be simplified more than the case shown in FIG. 9 (only both ends of a bold rob member may be made to be machined to a small diameter).

Further, according to the striker of Embodiment 3, it is comparatively easy to adopt cold forging of caulking the one end 21 and the other end 22 of the rod member 29 without heating the rod member 29. That is, the stepped portions 21f and 22f in correspondence with the surface side caulking ball portions 21p and 22p of the striker 1 of Embodiment 1 are previously formed, and therefore, when the one end 21 and the other end 22 are caulked by cold forging to form the back face side caulking ball portions 21q and 22q and the one end 21 and the other end 22 are made to plastically flow in the screw grooves 11a and 12a, operation and effect of the invention can be achieved.

Although an explanation has been given of the invention based on Embodiments 1 through 3 as described above, the invention is not limited to Embodiments 1 through 3 mentioned above but naturally applicable by being changed in the range not deviated from the gist.

For example, the burn-caulking apparatus 90 is not limited to the one shown in FIG. 5 and FIG. 6 but may be constituted by making upside down or constituent elements and operation thereof may differ.

Further, the method of manufacturing the striker 1 may include a step other than the preparing step, the groove forming step, the arranging step and the burn-caulking step described above.

Further, as shown by FIG. 11, the invention is applicable to a striker 100 including a base plate 110 made of a steel penetrated with one post hole and a post 120 projected from the base plate 110 by caulking an end portion of a rod member made of a steel in a state of being inserted to the post hole.

As caulking, for example, there can be adopted burn caulking (hot forging, precast forging) for pressing an end portion of a rod member while heating to soften the end portion thereof by high-frequency heating or the like, or caulking (cold forging) for pressing the rod member without heating the rod member.

When the end portion of the rod member is made to flow plastically even by a small amount at inside of the groove formed at the inner face of the post hole, the rattle can be made to be difficult to be brought about in comparison with the striker of the background art, further, it is further preferable to constitute a state in which the end portion of the rod member is made to plastically flow to fill inside of the groove. Thereby, the coupling of the post to the base plate becomes further solid, and therefore, operation and effect of the invention can further be achieved.

A groove of a general shape of a screw groove, a V-groove, a rectangular groove, a semicircular groove or the like can be adopted. In the case of the groove turning around the inner face, a plurality of grooves may be formed in a thickness direction of the base plate.

The invention can be utilized in a lock apparatus of a vehicular opening/closing member.

1. A striker which is used for a vehicular opening/closing member, and which comprises:
a base plate made of a steel penetrated with a post hole; and
a post projected from the base plate by being caulked in a state of inserting an end portion of a rod member made of a steel to the post hole,
characterized in that
an inner face of the post hole is formed with at least one groove recessed in an outer direction of a diameter relative to an axis center of the post hole; and
the end portion of the rod member clamps a surface side edge and a back face side edge of the post hole and is made to plastically flow at inside of the groove.

2. The striker which is used for a vehicular opening/closing member according to claim 1, characterized in that the base plate is penetrated with the two post holes, and the post is constituted by folding to bend the rod member substantially in a U-like shape.

3. The striker which is used for a vehicular opening/closing member according to claim 1, characterized in that the groove is a screw groove.

4. The striker which is used for a vehicular opening/closing member according to claim 1, characterized in that the groove is a circle groove turning around the inner face.

5. The striker which is used for a vehicular opening/closing member according to claim 1, characterized in that the end portion of the rod member includes a stepped portion butted to and stopped by a peripheral edge of the post hole when the post is inserted to the post hole.

6. A method of manufacturing a striker which is used for a vehicular opening/closing member, and which comprises:
a base plate made of a steel penetrated with a post hole; and
a post projected from the base plate by being caulked in a state of inserting an end portion of a rod member made of a steel to the post hole,
the method characterized by comprising:
a groove forming step of forming at least one groove recessed in an outer direction of a diameter relative to an axis center of the post hole at an inner face of the post hole; and
a caulking step of clamping a surface side edge and a back face side edge of the post hole by the end portion of the rod member and making the end portion thereof plastically flow at inside of the groove.
